(19) United States
(12) Patent Application Publication
(10) Pub. No.: US 2007/0185749 A1
(43) Pub. Date: Aug. 9, 2007

(54) Method for tracking hand-harvested orchard crops

(76) Inventors: Noel Wayne Anderson, Fargo, ND (US); Douglas Jeffrey Dickman, Normal, IL (US); Stephen Michael Faivre, Kingston, IL (US); Timothy Amos Wilcox, Loraine, IL (US)

Correspondence Address: DEERE & COMPANY, ONE JOHN DEERE PLACE, MOLINE, IL, 61265, US

(21) Appl. No.: 11/348,912

(22) Filed: Feb. 7, 2006

(51) Int. Cl. G06F 9/44; G07F 19/00; G06F 7/00; G08B 13/14; G08B 23/00

(52) U.S. Cl. 705/7; 705/30; 235/376; 340/572.1; 340/573.1

(57) ABSTRACT

A method for tracking hand-harvested orchard crops includes associating with each tree of interest in an orchard a corresponding first wireless communication device; outfitting each worker that is working in the orchard with a corresponding second wireless communication device; associating with each produce bin that is actively used in the orchard a corresponding third wireless communication device; and generating tracking information for tracking a crop flow from a particular tree via a particular worker to a particular produce bin using information provided by the corresponding first wireless communication device, the corresponding second wireless communication device, and the corresponding third wireless communication device.

### FIELD OF THE INVENTION

The present invention is directed to tracking crops, and more particularly, to a method for tracking hand-harvested orchard crops.

### BACKGROUND OF THE INVENTION

Significant progress has been made in the ability to trace food from the field to the table over the past decade. Mechanically harvested crops, such as corn, wheat, and beans, have been traced at harvest using yield monitors with global positioning system (GPS) receivers since the early 1990s. Bar codes and radio frequency identification (RFID) readers facilitate the tracking of fruits and vegetables after arriving in bins at processing plants, like other industries handle components and finished goods through a factory.

One closed environment where crop tracing has been used to track hand-harvested crops is the hydroponic environment. A key feature of this environment is that electrical power for data acquisition and transfer is readily available. Also, the hydroponic environment is an indoor environment that permits the use of equipment designed for use in warehouses versus the harsher outdoors. In addition, hydroponic crops, e.g., tomatoes, command a price premium that can cover higher information technology costs, in contrast to fruits and vegetables grown outdoors.

Also, there are key differences between produce grown on trees or shrubs, and produce grown in open fields. One difference is that trees or shrubs persist from year to year with tractor-wide rows between them, whereas stem or vine produce, e.g., vegetables, grown in open fields have narrower rows with different harvest item field aggregation. Another difference is that the tree canopies can block or degrade electronic signals, whereas stem or vine produce grown in outdoor fields typically have open skies. Still another difference is that the fields of stem or vine produce typically are plowed up at the end of the growing season.

### SUMMARY OF THE INVENTION

The present invention facilitates the tracking of hand-harvested orchard crops from the tree from which the produce was picked to the produce bin that receives the picked produce, and then transported to a storage or processing facility.

The invention, in one form thereof, is directed to a method for tracking hand-harvested orchard crops. The method includes associating with each tree of interest in an orchard a corresponding first wireless communication device, each corresponding first wireless communication device uniquely identifying a particular tree of a plurality of trees in the orchard; outfitting each worker that is working in the orchard with a corresponding second wireless communication device, each corresponding second wireless communication device uniquely identifying a particular worker of a plurality of workers working in the orchard; associating with each produce bin that is actively used in the orchard a corresponding third wireless communication device, each corresponding third wireless communication device uniquely identifying a particular produce bin of a plurality of produce bins being used in the orchard; and generating tracking information for tracking a crop flow from the particular tree via the particular worker to the particular produce bin using information provided by the corresponding first wireless communication device, the corresponding second wireless communication device, and the corresponding third wireless communication device.

The invention, in another form thereof, is directed to a method for tracking hand-harvested orchard crops. The method includes associating with each tree of interest in an orchard a corresponding first wireless communication device; outfitting each worker that is working in the orchard with a corresponding second wireless communication device; associating with each produce bin that is actively used in the orchard a corresponding third wireless communication device; generating tracking information for tracking a crop flow from a particular tree via a particular worker to a particular produce bin using information provided by the corresponding first wireless communication device, the corresponding second wireless communication device, and the corresponding third wireless communication device; and forwarding the tracking information to a central processing station.

### BRIEF DESCRIPTION OF THE DRAWINGS

FIG. 1 is an exemplary diagrammatic representation of an orchard having a plurality of trees from which produce is picked and tracked in accordance with embodiments of the present invention.

FIG. 2 is a flowchart of a general method for tracking hand-harvested orchard crops.

FIG. 3 is an embodiment of a monitoring device that may be used in association with the method of FIG. 2.

### DESCRIPTION OF THE PREFERRED EMBODIMENT

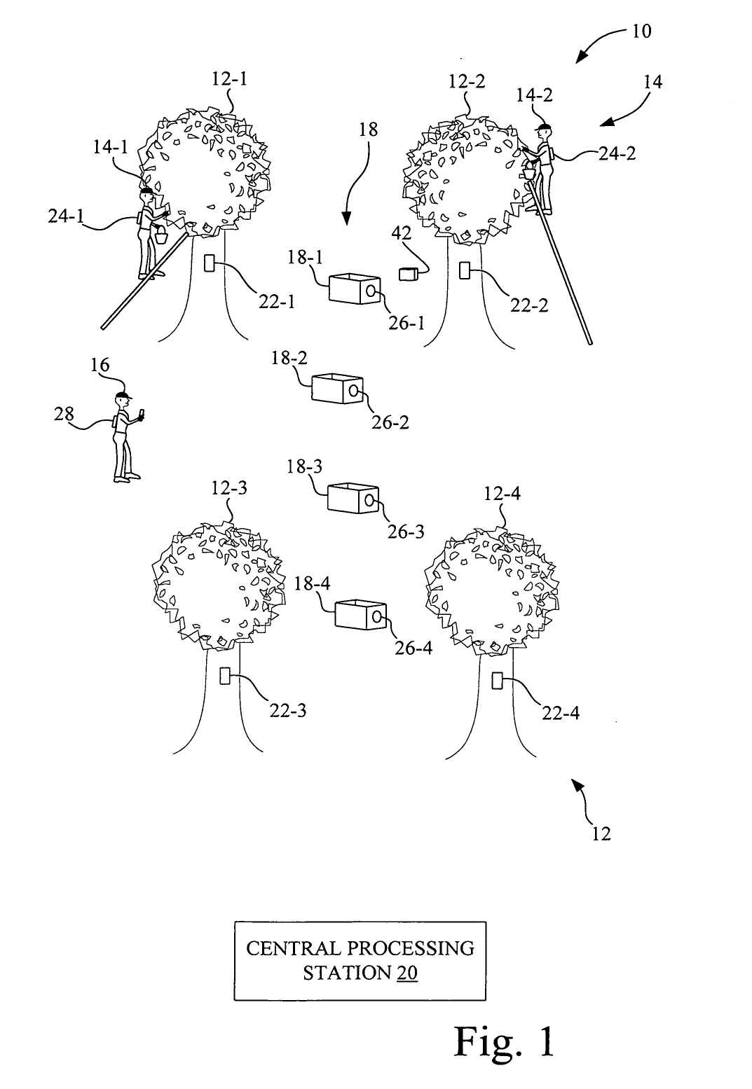

Referring now to the drawings, there is shown in FIG. 1 an exemplary diagrammatic representation of an orchard 10 having a plurality of trees 12, individually identified as tree 12-1, tree 12-2, tree 12-3, and tree 12-4. For convenience, the term “trees” includes both trees and shrubs. Trees 12 are trees that yield a produce crop, such as fruit, nuts, coffee beans, etc.

Working in orchard 10 is a plurality of workers 14, individually identified as worker 14-1 and worker 14-2. Also working in orchard 10 is a supervisor 16. Placed in orchard 10 is a plurality of produce bins 18, individually identified as produce bin 18-1, produce bin 18-2, produce bin 18-3, and produce bin 18-4. A remote central processing station 20 is provided to receive tracking information relating to crop flow within, and out of, orchard 10.

Workers 14 may use ladders to reach the produce, e.g., fruit, which is high in a tree. The hand-picked produce is optionally placed in a bucket, or other small container, before being placed in one of the produce bins 18 for transport to a storage and processing facility. Typically, such produce bins 18 are made of wood or plastic, and are approximately 4 feet×4 feet×4 feet in size. A number of the plurality of produce bins 18 may be in close proximity with each other. Accordingly, each produce bin may receive produce of mixed grades, which are then sorted at a remote location. Alternately, each produce bin may be designated to receive produce of a particular grade. For example, fruit in a particular produce bin, e.g., produce bin 18-1, may be picked from multiple trees of the plurality of trees 12, and harvested by multiple workers 14.

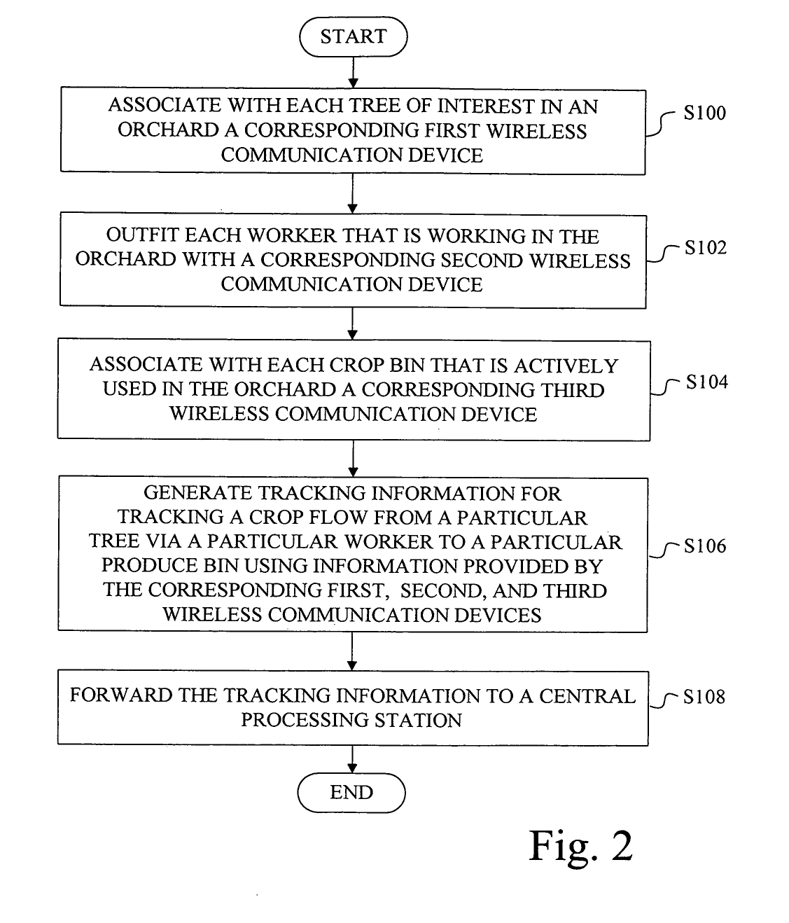

FIG. 2 is a flowchart of a general method for tracking hand-harvested orchard crops, in accordance with embodiments of the present invention. Following the discussion of the general steps set forth in FIG. 2, several exemplary embodiments illustrating application of the method will be described.

At step S100, with reference to the example of FIG. 1, associated with each tree 12-1,12-2,12-3, 12-4 of interest of the plurality of trees 12 is a corresponding wireless communication device 22, with each corresponding wireless communication device being individually identified as wireless communication device 22-1, wireless communication device 22-2, wireless communication device 22-3, and wireless communication device 22-4. Each corresponding wireless communication device 22-1, 22-2, 22-3, 22-4 uniquely identifies a particular tree 12-1,12-2, 12-3,12-4, respectively, of the plurality of trees 12 in orchard 10. For example, each wireless communication device 22 may be physically located on or near a respective tree of the plurality of trees 12.

At step S102, each worker 14-1, 14-2 of the plurality of workers 14 that is working in orchard 10 is outfitted with a corresponding wireless communication device 24, the corresponding wireless communication device being individually identified as wireless communication device 24-1 and wireless communication device 24-2. Each corresponding wireless communication device 24-1, 24-2 uniquely identifies a particular worker 14-1,14-2, respectively, of the plurality of workers 14 working in orchard 10.

Each of the wireless communication devices 24 may be designed to be worn by the respective worker. For example, each of the wireless communication devices 24 may be configured as a belt, necklace or backpack, or configured for attachment to an article of clothing worn by a worker, or to the worker's bucket. Wireless communication devices 24 are designed such that their size and weight will not impair the harvest work or tire the workers from the added weight.

At step S104, associated with each produce bin 18-1,18-2,18-3,18-4 of the plurality of produce bins 18 that is actively used in orchard 10 is a corresponding wireless communication device 26, each corresponding wireless communication device being individually identified as wireless communication device 26-1, wireless communication device 26-2, wireless communication device 26-3, and wireless communication device 26-4. Each corresponding wireless communication device 26-1, 26-2, 26-3, 26-4 uniquely identifies a particular produce bin 18-1, 18-2, 18-3, 184, respectively, of the plurality of produce bins 18 being used in orchard 10. Each wireless communication device 26, for example, may be physically located on, e.g., detachably attached to, a respective produce bin of the plurality of produce bins 18.

At step S106, tracking information for tracking a crop flow from a particular tree, e.g., tree 12-1, via a particular worker, e.g., worker 14-1, to a particular produce bin, e.g., produce bin 18-1, is generated, e.g., by a monitor device 28 or 28a, using information provided by, in this example, corresponding wireless communication device 22-1, corresponding wireless communication device 24-1, and corresponding wireless communication device 26-1. Thus, the tracking information is in the form of an electronic record of the trees and workers associated with the produce contained in a particular produce bin.

At step S108, the tracking information, generated through automated data collection, is forwarded, e.g., by the monitor device 28 or 28a, or a removable memory device, to central processing station 20. Central processing station 20 may, for example, execute program instructions to process the tracking information to perform various tasks, such as generating payroll and/or supply chain management operations, based on the tracking information. For example, the tracking information may be used to provide merit pay adjustments based on the quality of fruit harvested as well as quantity. In addition, the tracking information may be used to identify workers who may have good work ethics, but need training to improve their harvesting skills.

Further, the tracking information may be used for individual tree and/or whole orchard management. For example, the tracking information facilitates tracing quality and quantity of fruit harvested from a particular tree, which in turn may be used to make management decisions about fertilizing, pruning, irrigation, replacement, etc., for that tree or other trees in the orchard.

### Embodiment 1

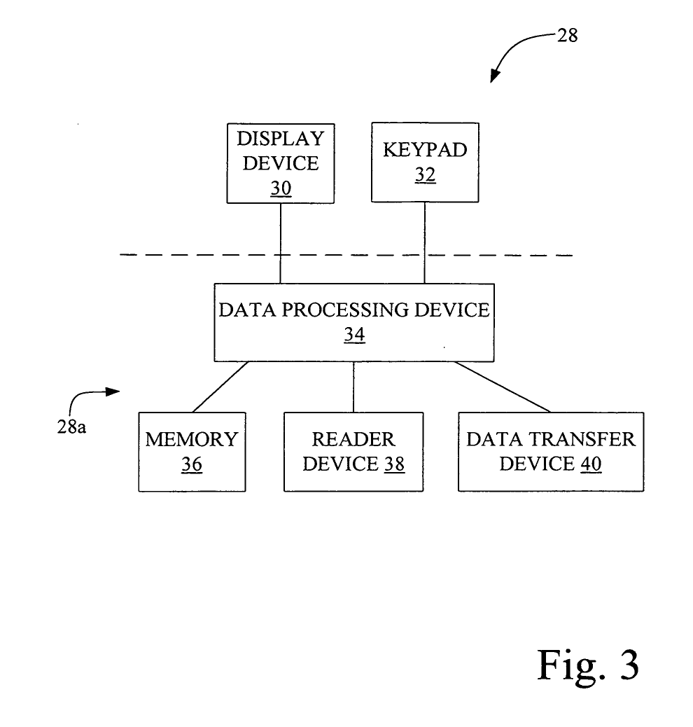

In summary, in Embodiment 1, tracking crop flow (see step S106 of FIG. 2) is performed using a monitor device 28. In this embodiment, as shown in FIG. 1, monitor device 28 is configured, for example, as a data terminal wearable by supervisor 16. Referring to FIG. 3, monitor device 28 may include, for example, a display device 30, a keypad 32, a data processing device 34, a memory 36, a reader device 38, and a data transfer device 40.

Display device 30 may include an LCD display and/or indicator lights for displaying user menus and tracking information. Keypad 32 facilitates manual entry of information, where necessary or desired. Data processing device 34 includes a microprocessor, and executes program instructions retrieved from memory 36. Memory 36 may be one or more of random access memory (RAM), read-only memory (ROM) and non-volatile RAM. Reader device 38 may be, for example, a radio frequency identification (RFID) tag reader or a bar code reader.

Data transfer device 40 transfers the tracking information generated at step S106 to central processing station 20. Data transfer device 40 may be a physical media, such as a compact flash or similar removable memory device, or it may be a long range wireless link such as cell phone, Wi-Fi, Wi-Max, etc., or a short range wireless link, such as Zigbee, Bluetooth, or IEEE 802.11

At the start of a work shift, for example, supervisor 16 operates monitor device 28 to record all trees 12, all workers 14, and all produce bins 18 grouped together as an ensemble for a hand-harvest activity. Monitor device 28 is configured to automatically read identification (ID) information provided by each wireless communication device 22, each wireless communication device 24 and each wireless communication device 26, to correlate the produce, e.g., fruit, picked from a particular tree, e.g., tree 12-2, by a particular worker, e.g., worker 14-2, with a particular produce bin, e.g., produce bin 18-2. In other words, monitor device 28 monitors the work flow of each worker with respect to particular trees and particular produce bins.

Whenever a tree is finished, a new tree is started, a worker arrives, a worker leaves, a bin is filled, or an empty bin is put into service, supervisor 16 reads the ID information and confirms entry or exit from service. Taken together, the active trees, workers, and produce bins define the crop flow for traceability purposes. A number of harvest ensembles may be active in orchard 10 at a given time and a single supervisor 16 may have responsibility for multiple ensembles, which is accommodated by monitor device 28.

Since all tree, worker and produce bin information is read by monitor device 28, each wireless communication device 22 associated with the plurality of trees 12 may be a passive identification device. Likewise, each wireless communication device 24 associated with workers 14 and each wireless communication device 26 associated with produce bins 18 may be a passive identification device. The passive identification device may be, for example, a radio frequency identification (RFID) tag. Alternatively, the passive identification device may be a bar code. The display and/or an optional audio output on monitor device 28 gives an indication of a successful read of the communication devices 22, 24, and 26 by the reader device 38 of monitor device 28.

Due to the potential remote location of orchard 10, each of communication devices 22, 24 and 26, and monitor device 28, may be powered by a portable energy source, if required, such as powered by batteries or a fuel cell. The power source needs to provide ample power for the desired period of time without power interruption, e.g., a work shift, a day, a season, or longer. Also, use of low power technologies will extend the time before battery replacement is required.

### Embodiment 2

In Embodiment 2, each worker's corresponding wireless communication device 24 includes a monitor device 28a (see FIG. 3), which may be similar to the construction of monitor device 28, but with reduced features to cut down on cost. Each wireless communication device 24 may be configured as a wearable device. Monitor device 28a includes data processing device 34, memory 36, reader device 38, and data transfer device 40 for transferring the tracking information to central processing station 20. Alternatively, however, one or more of the corresponding wireless communication device 24 may include the full-featured monitor device 28.

In Embodiment 2, the tracking step S106 of FIG. 2 is performed using monitor device 28a of a worker's wireless communication device 24, e.g., wireless communication device 24-1 of worker 14-1, to read information provided by each tree's wireless communication device 22-1, 22-2, etc., that is communicatively engaged by the corresponding worker's wireless communication device 24-1, and using monitor device 28a of wireless communication device 24-1 to read information provided by each produce bin's wireless communication device 26, e.g., wireless communication device 26-2 of produce bin 18-2, communicatively engaged by wireless communication device 24-1, which in this example, correlates the produce, e.g., fruit, picked from the particular tree 12-1, by the particular worker 14-1, with the particular produce bin 18-2.

Workers may still have RFID tags which may be read by either of monitor device 28 or monitor device 28a. Alternatively, where monitor device 28 is used, a worker may enter a worker ID manually via keypad 32 at the beginning and end of each work period. In embodiments where each tree's wireless communication device 22 is an RFID tag, it is desirable that the tree RFID tags be readable from a distance of several meters. In embodiments where each bin's wireless communication device 26 is an RFID tag, it may be desirable for the bin RFID tags to be readable from a distance of less than a meter.

In order to lengthen the work time available from the plurality of wireless communication devices 24 used by workers 14, each worker's wireless communication device 24 operates in an active mode only periodically to conserve electrical power. Further, each worker's wireless communication device 24 is configured, e.g., through the execution of program instructions, to perform a learning operation by analyzing the tracking information to determine an optimal periodic sampling time for operating in the active mode.

For example, the optimal sampling period for a worksite will depend on a variety of factors, such as for example, the difficulty of harvesting the produce, the size of the produce and buckets, and the distance from the tree to the produce bin. This optimal sampling period may range, for example, from several times a minute to once every several minutes. To further reduce energy use, the period may be variable as a part of an adaptive learning component, recognizing that once a harvest of a particular tree has started, it will be a while before the bucket is full and needs to be emptied into a produce bin. Thus, the sampling period may be lengthened. As the estimated level of the bucket increases, the sampling rate may be increased so that the transfer of the produce from the bucket to the produce bin is captured. The sampling period then may be decreased once a tree identification, e.g., an RFID tag as wireless communication device 22, is again read.

At the end of the work shift, each of the wireless communication devices 24 are retrieved from each of the workers 14 and the tracking information may be transferred via a short range wireless or physical storage media to central processor station 20. Alternatively, long range wireless, e.g., Wi-Max and cellular phone, may be used to transfer tracking information throughout the work shift.

In Embodiment 2, the work path taken, for example, by worker 14-2 may cause wireless communication device 24-2 of worker 14-2 to read multiple produce bins, e.g., produce bin 18-1 and produce bin 18-2.

In one scenario of the above, assume that worker 14-2 walks past produce bin 18-2 to empty a bucket of produce, e.g., fruit, in produce bin 18-1. If wireless communication device 24-2 of worker 14-2 reads multiple bin wireless communication devices, e.g., wireless communication device 26-2 and then wireless communication device 26-1, corresponding to produce bins 18-2 and 18-1, respectively, then it is inferred that the last wireless communication device 26-1 of the multiple wireless communication devices 26-1 and 26-2 that is engaged by wireless communication device 24-2 of worker 14-2 identifies the particular produce bin 18-1 in which worker 14-2 emptied the bucket of produce, e.g., fruit.

In another scenario, assume worker 14-1 walks past produce bin 18-1 to empty a bucket of produce, e.g., fruit, in produce bin 18-2. If the wireless communication device 24-1 of worker 14-1 reads both wireless communication device 26-1 of produce bin 18-1 and wireless communication device 26-2 of produce bin 18-2, then it is inferred that the particular wireless communication device of the multiple wireless communication devices 26-1 and 26-2 that is engaged by wireless communication device 24-1 for the longest period of time identifies the particular produce bin in which worker 14-1 emptied the bucket of produce.

Alternatively, it may be inferred that a particular wireless communication device of the multiple wireless communication devices 26-1 and 26-2 having the strongest signal strength signature read by wireless communication device 24-1 identifies the particular produce bin in which worker 14-1 emptied the bucket of produce.

In another scenario, each of wireless communication device 26-1 corresponding to produce bin 18-1, communication device 26-2 corresponding to produce bin 18-2, communication device 26-3 corresponding to produce bin 18-3, and communication device 26-4 corresponding to produce bin 18-4 includes a plurality of RFID tags positioned at different locations, e.g., on multiple sides, on the respective produce bin 18-1, 18-2, 18-3, and 18-4. In this scenario, assume worker 14-1 walks past produce bin 18-1 to empty a bucket of produce, e.g., fruit, in produce bin 18-2. If wireless communication device 26-1 of worker 14-1 reads multiple wireless communication devices 26-1, 26-2 corresponding to produce bins 18-1, 18-2, respectively, then it is inferred that a particular wireless communication device 26-2 of the multiple wireless communication devices 26-1, 26-2 having the most RFID tags read by wireless communication device 24-1 identifies the particular produce bin in which worker 14-1 emptied the bucket of produce, e.g., fruit.

### Embodiment 3

In Embodiment 3, a particular produce bin, e.g., produce bin 18-1, is associated with a particular tree, e.g., tree 12-1. This association may be, for example, in the form of scanning a removeable RFID tag associated with the tree, entering the tree identification via the optional keypad, or having supervisor 16 with monitor device 28 read the tree identification and produce bin identification to form a link between the tree and the produce bin.

Each produce bin's wireless communication device 26 includes a monitor device 28a, or alternatively the full-featured monitor device 28, such that the tracking of step S106 of FIG. 2 is performed using the monitor device of the produce bin's wireless communication device 26 to read information provided by each worker's wireless communication device 24 that is communicatively engaged by the corresponding wireless communication device, e.g., wireless communication device 26-1, to correlate produce picked from a particular tree, e.g., tree 12-1, by a particular worker, e.g., worker 14-1, with a particular produce bin 18-1. Each bin's wireless communication device 26, including for example monitor device 28, may be configured as a detachably attachable unit that is attached to a corresponding produce bin 18.

In one scenario, each corresponding worker's wireless communication device, e.g., wireless communication device 24-1 of worker 14-1, may be attached to a corresponding bucket used by worker 14-1. The particular produce bin, e.g., produce bin 18-1, includes an electronic scales 42 (see FIG. 1) for weighing the corresponding bucket. Scales 42 provides a weight of the produce in the weighed bucket to wireless communication device 26-1, in this example.

Accordingly, when the tracking information, including produce weight, is processed by central processing station 20, workers 14 may be paid individually based on harvest weight rather than as a team assigned to fill a bin volume. Also, the weight of the produce placed in a particular bin may be used to ensure that trucks transporting the produce bins do not exceed highway weight limits. Also, scales 42 provides to the produce processing plant not only volume information, but also weight information.

### Embodiment 4

In Embodiment 4, each tree's wireless communication device 22 is a node on a network, e.g., a low power wireless network, wherein each tree's wireless communication device 22-1, 22-2, 22-3 and/or 22-4, reads each worker's corresponding wireless communication device 24 that is communicatively engaged by the corresponding tree's wireless communication device 22, and each worker's corresponding wireless communication device 24 reads each bin's corresponding wireless communication device 26 that is communicatively engaged by the corresponding worker's wireless communication device 24, to correlate the produce picked from a particular tree by a particular worker with a particular produce bin.

In addition, each tree's wireless communication device 22 may provide localized orchard sensing, such as temperature sensing, moisture sensing, etc. Such temperature sensors may be used for helping determine when to light smudge pots or turn on fans to mitigate frost damage. Soil moisture sensors may be used to help manage irrigation. Also, the nodes, with unique IDs, may be used to localize autonomous tractors moving through the rows between trees.

In one scenario, each worker's wireless communication device 24 and each bin's wireless communication device 26 may be another node on the wireless network, or a passive identification device, such as an RFID tag.

In another scenario, each worker's wireless communication device 24 is a monitor device, such as monitor device 28 or monitor device 28a, and each bin's wireless communication device 26 may be another node on the wireless network, or a passive identification device, such as an RFID tag. The tracking of step S106 is performed using monitor device 28, or monitor device 28a, to read information provided by each bin's wireless communication device 26 communicatively engaged by the monitor device. The monitor device then is used to transmit the tracking information to a closest tree's communication device node on the wireless network. For example, referring to FIG. 1, the monitor device represented by wireless communication device 24-1 associated with worker 14-1 would transmit the tracking information to the node represented by wireless communication device 22-1 on the wireless network associated with tree 12-1.

The low power network may access the outside world through, but not limited to, one or more of the following: (a) a stationary FNIS node, (b) network gateways on vehicles such as tractors, or (c) data collection devices, e.g., wireless communication devices 22, 24 and 26, and monitor devices 28 and 28a, as described in the previous embodiments.

In one variant of this embodiment, the base network is permanent and multifunction in that it is used for orchard sensing and localization as well as to track produce flow via one node per tree. Power is conserved by limiting transmit power to be adequate for reaching the adjacent 4-8 trees rather than, say, the typical full 50 meter range of Zigbee. Power is also conserved by implementing a variable duty cycle, i.e., when there is not much activity in the orchard, such that nodes may wake up only once a day during periods of relative inactivity, but at critical times such as harvest, drought, or frost, nodes may wake up several times an hour or a minute.

Workers 14 and produce bins 18 have corresponding wireless communication devices 24 and 26, respectively, providing ID information based on short range wireless and/or RFID. For example, when a worker empties a bucket of produce into a produce bin, a node worn by the worker picks up the ID of the produce bin. Whether the produce bin ID is an RFID tag or another short range wireless node, issues in automatically disambiguating adjacent produce bins as the recipient of produce exist as described and solved in Embodiment 2 described above. The end result is that the device worn by the worker contains the ID of the produce bin receiving the produce.

When the worker returns within range of a tree, the previous tree-fruit-worker-bin association is transferred to the tree node. If a worker is close to a particular tree, based on relative signal strength of all tree node signals being received, for a period of time, that tree ID is logged in the worker node as the current tree. The current tree ID is used in constructing the next tree-fruit-worker-bin association. These associations may have a time stamp added to assist in reconstructing the fruit movement from tree to bin. In this embodiment, the only long term data storage is in the tree node. Also, the tracking information leaves the orchard when the tree node network communicates with a gateway node of another network.

In another variation of this embodiment, the tree node may be moved to a ladder, and a localization device (e.g., GPS) and an optional scale provided. The ladder would get a tree ID by manual entry of a tree ID code, evaluating RF signal strength to conclude it is closest to a tree node with a given ID number, or reading an RFID tag on the tree. A GPS device, or other localization device, is desirable since the ladders will move, unlike stationary trees. The GPS tagged data may be later referenced to a map of the orchard. The optional scale may be used to weigh and record bucket contents, as in Embodiment 3.

The ladder variant may be used where trees are not identified with a network node or RFID. Also, there will typically be one ladder node per worker, and one GPS device per ladder. Placing the GPS device on the ladder helps get the GPS device above some of the orchard foliage for improved satellite signal strength and position accuracy. The GPS and tree node may also be placed on a separate moveable pole, if desired.

Having described various preferred embodiments, it will become apparent that various modifications can be made without departing from the scope of the invention as defined in the accompanying claims.

1. A method for tracking hand-harvested orchard crops, comprising:
associating with each tree of interest in an orchard a corresponding first wireless communication device, each said corresponding first wireless communication device uniquely identifying a particular tree of a plurality of trees in said orchard;
outfitting each worker that is working in said orchard with a corresponding second wireless communication device, each said corresponding second wireless communication device uniquely identifying a particular worker of a plurality of workers working in said orchard;
associating with each produce bin that is actively used in said orchard a corresponding third wireless communication device, each said corresponding third wireless communication device uniquely identifying a particular produce bin of a plurality of produce bins being used in said orchard; and
generating tracking information for tracking a crop flow from said particular tree via said particular worker to said particular produce bin using information provided by said corresponding first wireless communication device, said corresponding second wireless communication device, and said corresponding third wireless communication device.

2. The method of claim 1, further comprising forwarding said tracking information to a central processing station.

3. The method of claim 2, wherein said central processing station performs at least one of payroll and supply chain management operations based on said tracking information.

4. The method of claim 1, wherein said corresponding second wireless communication device is worn by said particular worker.

5. The method of claim 1, wherein said corresponding second wireless communication device is attached to a bucket used by said particular worker.

6. The method of claim 1, wherein said tracking is performed using a monitor device, said monitor device reading information provided by each first wireless communication device, second wireless communication device and third wireless communication device to correlate produce picked from said particular tree by said particular worker with said particular produce bin.

7. The method of claim 6, wherein a supervisor operates said monitor device to record all trees, workers and produce bins grouped together as an ensemble for a hand-harvest activity.

8. The method of claim 1, wherein each first wireless communication device, second wireless communication device and third wireless communication device is a passive identification device.

9. The method of claim 8, wherein said passive identification device is an RFID tag.

10. The method of claim 1, wherein said corresponding second wireless communication device includes a monitor device, said tracking being performed using said monitor device to read information provided by each first wireless communication device communicatively engaged by said corresponding second wireless communication device, and using said monitor device to read information provided by each third wireless communication device communicatively engaged by said corresponding second wireless communication device, to correlate produce picked from said particular tree by said particular worker with said particular produce bin.

11. The method of claim 10, wherein said corresponding second wireless communication device operates in an active mode only periodically to conserve electrical power.

12. The method of claim 11, wherein said corresponding second wireless communication device performs a learning operation by analyzing said tracking information to determine an optimal periodic sampling time for operating in said active mode.

13. The method of claim 10, wherein if said corresponding second wireless communication device of said particular worker reads multiple third wireless communication devices corresponding to multiple produce bins, then it is inferred that a last third wireless communication device of said multiple third wireless communication devices that is engaged by said corresponding second wireless communication device identifies said particular produce bin in which said particular worker emptied a bucket of produce.

14. The method of claim 10, wherein if said corresponding second wireless communication device of said particular worker reads multiple third wireless communication devices corresponding to multiple produce bins, then it is inferred that a particular third wireless communication device of said multiple third wireless communication devices that is engaged by said corresponding second wireless communication device for the longest period of time identifies said particular produce bin in which said particular worker emptied a bucket of produce.

15. The method of claim 10, wherein said each corresponding third wireless communication device includes a plurality of RFID tags positioned at different locations on each produce bin of said plurality of produce bins, and wherein if said corresponding second wireless communication device of said particular worker reads multiple third wireless communication devices corresponding to multiple produce bins, then it is inferred that a particular third wireless communication device of said multiple third wireless communication devices having the most RFID tags read by said corresponding second wireless communication device identifies said particular produce bin in which said particular worker emptied a bucket of produce.

16. The method of claim 10, wherein if said corresponding second wireless communication device of said particular worker reads multiple third wireless communication devices corresponding to multiple produce bins, then it is inferred that a particular third wireless communication device of said multiple third wireless communication devices having the strongest signal strength signature read by said corresponding second wireless communication device identifies said particular produce bin in which said particular worker emptied a bucket of produce.

17. The method of claim 1, further comprising:
associating said particular produce bin with said particular tree; and
wherein each said corresponding third wireless communication device includes a monitor device, said tracking being performed using said monitor device to read information provided by each said corresponding second wireless communication device communicatively engaged by said corresponding third wireless communication device to correlate produce picked from said particular tree by said particular worker with said particular produce bin.

18. The method of claim 17, wherein said monitor device is detachably attachable to said particular produce bin.

19. The method of claim 17, wherein each said corresponding second wireless communication device is attached to a corresponding bucket used by said particular worker.

20. The method of claim 19, wherein said particular produce bin includes a scales for weighing said corresponding bucket, said scales providing a weight of produce in said corresponding bucket to said corresponding third wireless communication device.

21. The method of claim 17, wherein tracking information collected by said monitor device is provided to a central processing station by one of a removable memory card and a wireless transmission.

22. The method of claim 1, wherein each first wireless communication device, each second wireless device, and each third wireless device is a node on a wireless network.

23. The method of claim 1, wherein each first wireless communication device is a node on a wireless network, wherein said corresponding first wireless communication device reads each corresponding second wireless communication device that is communicatively engaged by said corresponding first wireless communication device, and each corresponding second wireless communication device reads each corresponding third wireless communication device that is communicatively engaged by said each corresponding second wireless communication device, to correlate produce picked from said particular tree by said particular worker with said particular produce bin.

24. The method of claim 23, wherein said each first wireless communication device provides localized orchard sensing.

25. The method of claim 23, wherein each second wireless device and each third wireless device is one of another node on said wireless network and a passive identification device.

26. The method of claim 23, wherein said each second wireless device is a monitor device and each third wireless device is an RFID tag, said tracking being performed using said monitor device to read information provided by each third wireless communication device communicatively engaged by said monitor device, and using said monitor device to transmit said tracking information to a closest first communication device node on said wireless network.

27. The method of claim 23, wherein nodes associated with said plurality of trees are removed and added to each ladder of a plurality of ladders.

28. The method of claim 27, further comprising adding a GPS device to each ladder of said plurality of ladders to aid in localizing said tracking information in said orchard.

29. A method for tracking hand-harvested orchard crops, comprising:
associating with each tree of interest in an orchard a corresponding first wireless communication device;
outfitting each worker that is working in said orchard with a corresponding second wireless communication device;
associating with each produce bin that is actively used in said orchard a corresponding third wireless communication device;
generating tracking information for tracking a crop flow from a particular tree via a particular worker to a particular produce bin using information provided by said corresponding first wireless communication device, said corresponding second wireless communication device, and said corresponding third wireless communication device; and
forwarding said tracking information to a central processing station.

30. The method of claim 29, wherein said forwarding includes at least one of a wireless transmission and delivery of a removable memory card.
